(19) United States
(12) Patent Application Publication
(10) Pub. No.: US 2025/0045017 A1
(43) Pub. Date: Feb. 6, 2025

(54) SUMMATION AND FLOATING POINT CONVERSION OF TENSOR RESULTS

(71) Applicant: Altera Corporation, San Jose, CA (US)

(72) Inventors: Martin Langhammer, Alderbury (GB); Bogdan Pasca, Toulouse (FR); Dongdong Chen, San Jose, CA (US); Ilya Ganusov, San Jose, CA (US)

(21) Appl. No.: 18/900,192

(22) Filed: Sep. 27, 2024

(51) Int. Cl. G06F 5/01; G06F 7/485

(52) U.S. Cl. CPC G06F 5/012; G06F 7/485

(57) ABSTRACT

Integrated circuit devices and circuitry for implementing and using efficient circuitry for summation of tensors having shared exponents and conversion into a floating-point format rae provided. Such circuitry may include first input circuitry to receive a first tensor in a fixed-point format having a first shared exponent and second input circuitry to receive a second tensor in the fixed-point format with a second shared exponent. Addition circuitry may add the first tensor and the second tensor, without first converting the first tensor and the second tensor to a floating-point format, to obtain a result in the floating-point format.

### BACKGROUND

This disclosure relates to efficient circuitry for summation of tensors having shared exponents and conversion into a floating-point format.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include arithmetic circuit blocks to perform arithmetic operations such as addition and multiplication. For example, a digital signal processing (DSP) block may supplement programmable logic circuitry in a programmable logic device, such as a field programmable gate array (FPGA). Programmable logic circuitry and DSP blocks may be used to perform numerous different arithmetic functions. Some artificial intelligence (AI) numerics use tensors with shared exponents, also known as block exponents. The known methods for adding multiple tensor components together are very expensive in terms of both area and latency.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of a floating-point adder to add two tensor dot products with shared exponents to produce a result in a floating-point format;

FIG. 4 is a diagram of bidirectional bit-shift circuitry;

FIG. 5 is a diagram of an efficient block floating-point adder that uses the bidirectional bit-shift circuitry of FIG. 4;

FIG. 6 is a block diagram of a three-path floating-point adder that includes a close path, a top path, and a bottom path to add two tensor dot products with shared exponents to produce a result in a floating-point format based on a difference between the shared exponents;

FIG. 7 is a block diagram of an INT4 integer format 10-element dot product with shared exponents;

FIG. 8 is a table illustrating dynamic range as a function of precision;

FIG. 9 is a block diagram of input normalization circuitry;

FIG. 10 is a block diagram of circuitry to update a shared exponent of a 10-element dot product before addition with another 10-element dot product;

FIG. 11 is an alignment diagram corresponding to a top path of the three-path floating-point adder;

FIG. 12 is an alignment diagram corresponding to a bottom path of the three-path floating-point adder;

FIG. 13 is a truth table describing rounding based on a guard bit (G) value post 1's complement in the bottom path;

FIG. 14 is a truth table describing rounding based on a last bit (L), a round bit (R), and a guard bit (G) value post 1's complement and post 2's complement in the bottom path;

FIG. 15 is a truth table describing rounding based on a round bit (R) value and a guard bit (G) value post 1's complement and post 2's complement in the bottom path;

FIG. 16 is a truth table describing rounding based on a guard bit (G) value in the bottom path;

FIG. 17 is a block diagram of the close path of the three-path floating-point adder;

FIG. 18 is a block diagram of the top path of the three-path floating-point adder;

FIG. 19 is a block diagram of the bottom path of the three-path floating-point adder;

FIG. 20 is a block diagram of rounding decision logic for a last (L) bit position;

FIG. 21 is a block diagram of rounding decision logic for a guard (G) bit position;

FIG. 22 is another block diagram of the three-path floating-point adder; and

FIG. 23 is a block diagram of a data processing system that may incorporate the integrated circuit.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Artificial intelligence (AI) computations on an integrated circuit often involves calculating tensor dot products. Some current AI numerics (such as the Microscaling Open Compute Project (MX OCP) standard) use tensors with shared exponents, which are also known as block exponents. Previous methods for adding multiple tensor components together are very expensive in terms of both area and latency. This disclosure introduces floating point addition circuitry that may enable increased efficiency to enable more widespread adoption of computations involving tensors with shared exponents. One example is a modified floating-point adder, which is about the same area and performance as a regular floating-point adder, but which enables the addition of two input tensors with shared exponents. The two input tensors are converted to floating point at a denormalization stage of the floating-point adder. This is done using new type of bidirectional denormalization shifter that can apply relative normalizations between the two inputs. Another example is a custom floating-point adder that is tuned to the smaller precisions often used by tensors. A new type of floating-point adder architecture, which uses three paths, is described. This new architecture includes a close path, a top far path, and a bottom far path. The bottom far path represents a path where only round (R), guard (G), and sticky (T) bits have values, which removes the rounding operation from the critical path. This new floating-point adder is both smaller and faster than any known architectures.

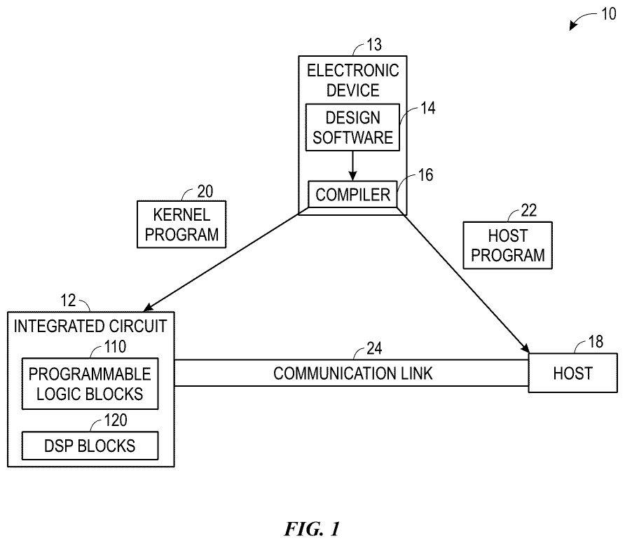

FIG. 1 illustrates a block diagram of a system 10 that may be used to implement system designs that use a floating-point adder of this disclosure on an integrated circuit system 12 (e.g., a single monolithic integrated circuit or a multi-die system of integrated circuits). A designer may desire to implement a system design on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks (e.g., LABs 110) on the integrated circuit system 12. The programmable logic blocks (e.g., LABs 110) may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

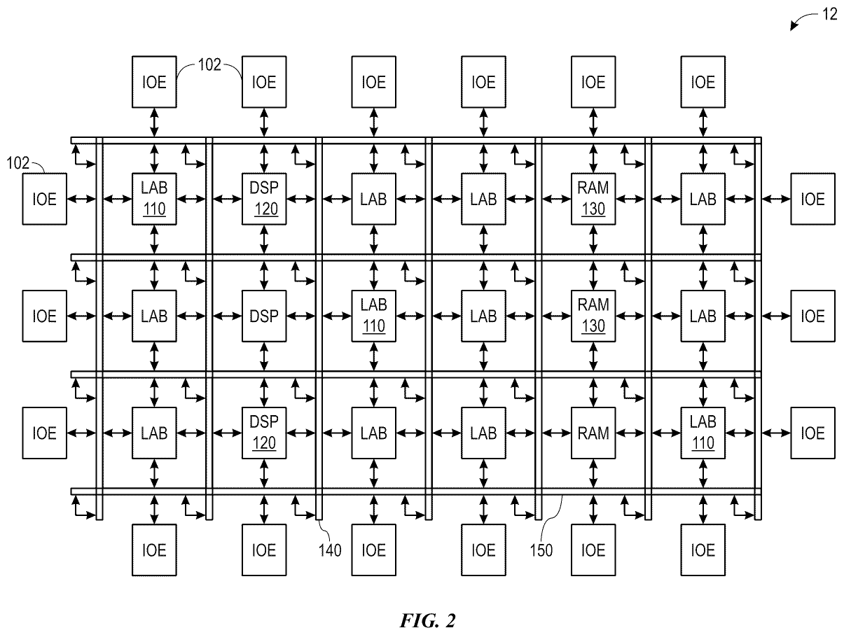

An illustrative embodiment of a programmable integrated circuit system 12 such as a programmable logic device (PLD) (e.g., a field programmable gate array (FPGA) device) that may be configured to implement a circuit design is shown in FIG. 2. As shown in FIG. 2, the integrated circuit system 12 (e.g., a field-programmable gate array (FPGA) integrated circuit device) may include a two-dimensional array of functional blocks sometimes referred to as arithmetic logic modules (ALMs), including programmable logic blocks (e.g., also referred to as logic array blocks (LABs) 110 or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic of the integrated circuit system 12 may be configured by programmable memory elements sometimes referred to as configuration random access memory (CRAM). Memory elements may be loaded with configuration data (also called programming data or configuration bitstream) using input-output elements (IOEs) 102. Once loaded, the memory elements each provide a corresponding static control signal that controls the operation of an associated functional block (e.g., LABs 110, DSP 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. The integrated circuit system 12 (e.g., as a programmable logic device (PLD)) may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the integrated circuit system 12) and horizontal routing channels 150 (i.e., interconnects formed along a horizontal axis of the integrated circuit system 12), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 2, are intended to be included within the scope of the present disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement. The integrated circuit system 12 may be programmed to perform a wide variety of operations, including floating point addition using a floating-point adder of this disclosure. The floating-point adder may be integrated into or formed using hardened circuitry (e.g., in the DSPs 120) or in soft logic of programmable logic circuitry (e.g., in the LABs 110).

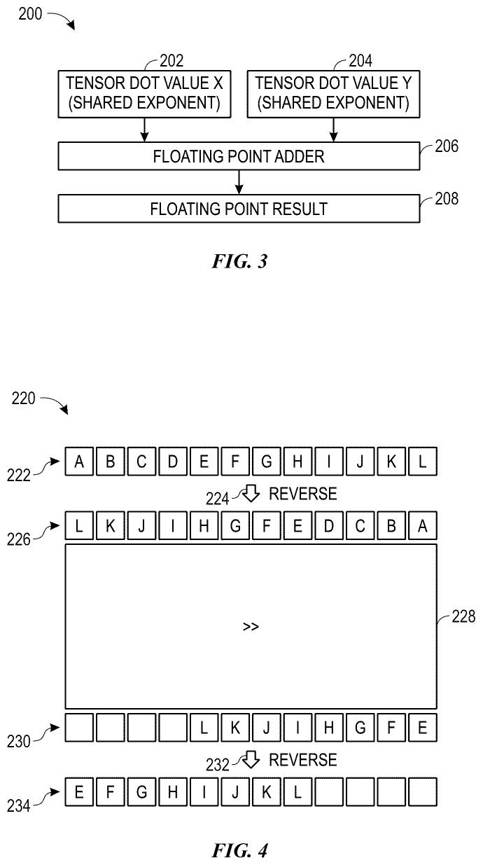

FIG. 3 is a block diagram of tensor addition 200 in which a first tensor dot value X 202 with a first shared exponent may be added to a second tensor dot value Y 204 with a second shared exponent. A floating-point adder 206, several examples of which are described below, may add the first tensor dot value X 202 and the second tensor dot value Y 204 to produce a floating-point result 208. The floating-point adder 206 adds two fixed point tensor results together while converting them to floating point at the same time. This can be expanded to any number of fixed-point tensor results being summed.

Tensor floating point addition is specified for many AI implementations. For example, the MX standard, which has been ratified by Open Compute Project (OCP), has an integer numeric with a shared exponent. As provided in this disclosure, such tensor floating point addition may be implemented using integer format (INT) numbers in a way that is much cheaper.

One example of the floating-point adder 206 may be implemented using a bidirectional bit-shifter 220, as shown in FIG. 4. Some hardened arithmetic circuits (e.g., DSPs 120) may include one bit-shifter. The bidirectional bit-shifter 220 may shift in either direction, reducing the amount of circuitry involved since a single bidirectional bit-shifter 220 may provide the same effect as two separate single-direction bit-shifters. The bidirectional bit-shifter 220 includes input circuitry 222 to receive some number of bits. In this example, the input circuitry 222 receives 12 bits, but other examples of the input circuitry 222 may include more or fewer. Reversal circuitry 224 may flip the arrangement of the input bits to an input 226 of a unidirectional shifter 228. Here, the unidirectional shifter 228 is a right shifter, but in other embodiments the unidirectional shifter 228 may be a left shifter. The unidirectional shifter 228 may shift the reversed input data on the input of the shifter 228 to produce shifted data 230 that, when reversed in second reversal circuitry 232, is shifted output data 234 that has been shifted by the opposite direction of the unidirectional shifter 228 (e.g., here, a left shift).

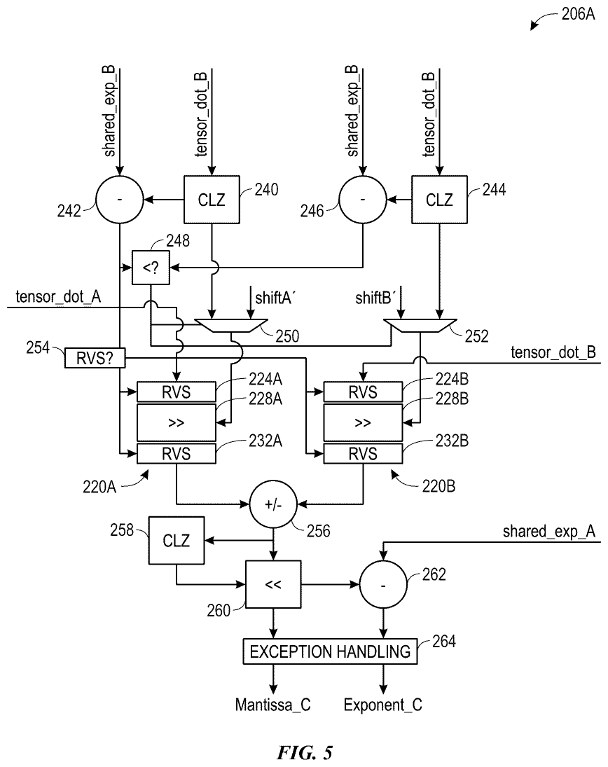

FIG. 5 illustrates a block floating-point adder 206A that performs floating point addition of two block floating point values (e.g., integer tensor values with an associated shared exponent) with denormalization assisted by the bidirectional bit-shifter 220. The block floating-point adder 206A has about the same complexity as a regular floating-point adder. Inputs include a first tensor (tensor dot A), an associated first shared exponent (shared exp A), a second tensor (tensor dot B), and an associated second shared exponent (shared exp B). The first shared exponent (shared exp A) is received into a count-leading-zeros (CLZ) circuit 240 that may obtain a count of the leading zeros of the first tensor (tensor dot A). The count of leading zeros from the CLZ circuit 240 is subtracted from the first shared exponent (shared exp A) by subtraction 242. Similarly, the second shared exponent (shared exp B) is received into a count-leading-zeros (CLZ) circuit 244 that may obtain a count of the leading zeros of the second tensor (tensor dot B). The count of leading zeros from the CLZ circuit 244 is subtracted from the second shared exponent (shared exp B) by subtraction 246.

A “less-than” selection block 248 determines which result from the subtraction 242 or 246 is smaller and provides a corresponding selection signal to multiplexers 250 and 252. The multiplexer 250 selects as a shift value either the count of leading zeros output by the CLZ circuit 240 or a ShiftA′ value. The multiplexer 252 selects as a shift value either the count of leading zeros output by the CLZ circuit 244 or a ShiftB′ value. The ShiftA′ and ShiftB′ values may be calculated based on the differences between the counts of leading zeros and the shared exponents. For instance, ShiftB′ may be computed as.

$$\begin{matrix}{ShiftB}^{′} = ( expA - CLZA ) - ( expB - CLZB ) - CLZA \\ = ( expA - CLZA - expB + CLZB - CLZA \\ = expA - expB + CLZB - 2 CLZA\end{matrix}$$

As should be appreciated, ShiftA′ may be computed in a like manner. A selection block 254 may determine whether reversal circuits 224A and 232A and/or 224B and 232B are to perform a forward or a reverse shift based on a relative value of the normalized first shared exponent and/or the normalized second shared exponent. The first tensor (tensor dot A) may be shifted in the bit-shifter 220A and the second tensor (tensor dot B) may be shifted in the bit-shifter 220B. The bit-shifters 220A and 220B are part of a denormalization stage of the floating-point adder 206A that effectively denormalize the tensors in relation to one another so that they may be added or subtracted 256. The result of the addition or subtraction 256 may then be renormalized. Count leading zeros (CLZ) circuitry 258 may determine the count of leading zeros and bit-shift circuitry 260 may shift the result accordingly. The count of leading zeros may also be subtracted 262 from the first shared exponent A. Exception handling circuitry 264 may adjust the output to avoid errors such as exponent overflows or underflows.

In effect, on the input, the dynamic range of the two inputs (tensor dot A with shared exp A and tensor dot B with shared exp B) is determined, and this is used to adjust the exponents. Both input values go through their own shifter 220A and 220B (rather than one shifter preceded by a mux). The larger input value is just normalized (left shift with the ‘1’ in the MSB). This is accomplished using the input and output reverse 224A, 224B, 232A, 232B wrapped around a right shift 228A, 228B. The other number is often right shifted, but there are occasions where it is also left shifted. A modified shift value is calculated (e.g., shiftA′, shiftB′) but since this value can be calculated on the input to the circuit, it will not impact the performance.

Take the right number (B) as an example. If this number is denormalized, the right shift value will be the difference between the left exponent and right exponent (if both numbers were normalized), minus the normalization difference of the left number. This may be further understood by a numerical example. Number A has a shared exponent of 140 and has a left shift of 5 to normalize the dot number. Number B has corresponding values {134, 8}. As such, the two normalized exponents are 135 and 126. Thus, number A is bigger, and number B is therefore right shifted by (135−126)=9 positions. But it is already right shifted by 8, so only actually needs a right shift by 1. This is shown by (140−5)−(134−8)−8=1.

The smaller number may also need to be shifted left. Here is an example of this. Number A is {140, 5}, and Number B is {138, 4}. The shift value may be equal to (140−5)−(138−4)−4=135−138=−3. This means to shift 3 bits to the right. This may be accomplished as follows:
1. Convert the shift value to a positive value (take the 2's complement).
2. Do not apply the bit reversal to the smaller value.

These can be accomplished by a few gates. The ShiftA′ and B′ values can be calculated well in advance—the two input exponents are available immediately on data entry, and the appropriate CLZ value is calculated immediately thereafter. If the size and combinatorial delay of this FP adder are compared to the standard adder, it may be found that the size and speed are very close, even with the additional step of calculating the CLZ on the input. This is because this adder does not check exceptions on the input. The “mantissa” is a fixed point value, so cannot contain any signaling (e.g., not a number (NaN)) information. The exponents, even when adjusted with the CLZ values, can simply be allowed to expand beyond their dynamic range (e.g., 8-bits in the case of FP32), and any exceptions may be applied at the output.

Other floating-point adders 206 that perform addition of tensors with shared exponents may take advantage of the relatively lower precisions that are often used in AI applications. For example, one particular application is the summation of two INT4 integer format 10-element dot products. Note that the INT8 integer format 10 element dot product may still be converted to a floating-point format such as FP32 using an existing method in a separate circuit, in parallel with the circuitry of this disclosure. With tensors of this precision, 11 bits are sufficient to store the 2's complement dot-products (the upper bits of the INT8 dot product may be used when calculating one of the two INT4 dot tensors for the column). Each dot-product (representing a half-column) has its own exponent, and the destination is an FP32 format.

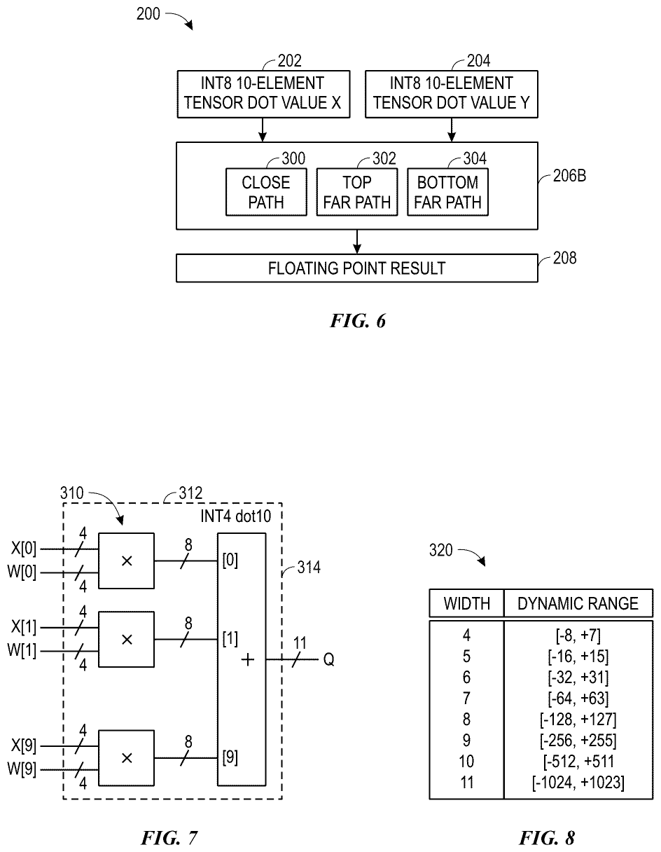

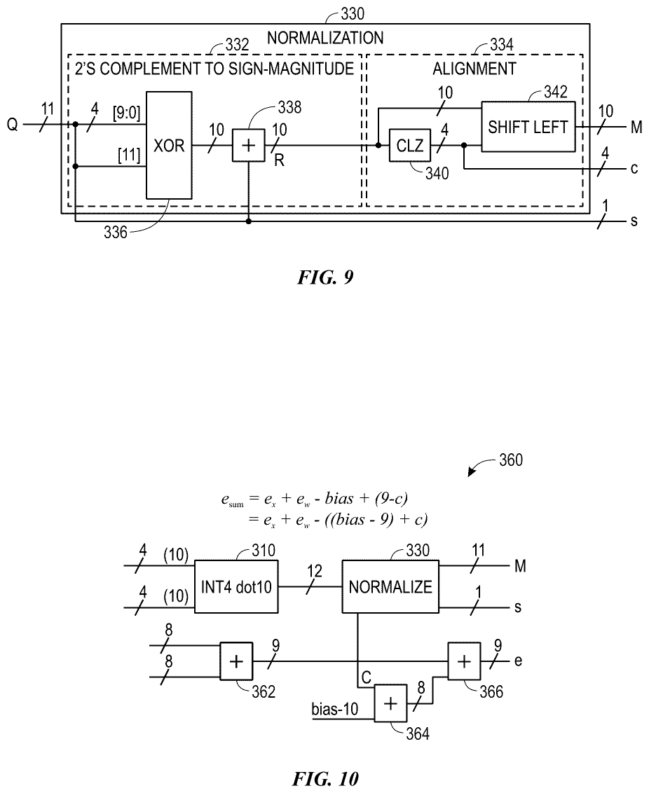

As shown in FIG. 6, this disclosure will describe another floating-point adder 206B that will not only calculate the FP32 value, but also may correctly round the FP32 result. FIG. 6 is a block diagram of tensor addition 200 in which a first INT8 10-element tensor dot value X 202 with a first shared exponent may be added to a second INT8 10-element tensor dot value Y 204 with a second shared exponent. A floating-point adder 206B may include multiple paths: a close (e.g., near) path 300, a top far path 302, and a bottom far path 304. Which path 300, 302, or 304 to use may depend on a difference in exponent between the first tensor dot value X 202 and the second tensor dot value 204. The resulting addition produces a floating-point result 208.

FIG. 7 illustrates a 4-bit integer (INT4) format, 10-element dot product circuit 310 that may generate the tensors 202 and/or 204. An array of multipliers 312 may multiply respective INT4 multiplicand x and INT4 multiplier w array elements. For example, element x[0] may be multiplied with element w[0], element x[1] may be multiplied with element w[1], . . . , element x[9] may be multiplied with element w[9]. The products of the multipliers 312 may be added together in summation circuitry 314. Even though there are 10 products being added in the summation circuitry 314, based on the range of possible values of the products, the resulting output Q will not exceed 11 bits.

For example, as shown by a table 320 in FIG. 8, one can calculate that an 11-bit datapath at the input of the floating-point adder 206B is sufficient. The reason is that 4-bit data containers allow for inputs in the range ∈[−8, +7]. The products x[i]−w[i]∈[−56, 64], and therefore the sum Q of 10 such products belongs to a set ∈[−560, 640]. In fact, it may be seen that more than 10 products may be summed and 11 bits may still be sufficient.

A normalization circuit 330 may normalize the 11-bit summation value Q with a conversion block 332 and an alignment block 334. The conversion block 332 may include an XOR circuit 336 and an integer adder 338. The alignment block may include count leading zeros (CLZ) circuit 340 and a shift left circuit 342. This circuit is similar to certain existing floating point adders, although this one explicitly converts the number Q to signed-magnitude format. In the conversion block 332, the number can be either signed magnitude or signed (e.g., two's complement). In the alignment block 334, the exponent is adjusted based on the normalization value. For example, the CLZ value is subtracted from the input exponent. The normalization circuit 330 outputs a 10-bit mantissa (M), a 4-bit count of leading zeros (c), and a sign bit (s).

FIG. 10 illustrates an example of tensor circuitry 360 representing other circuitry that may generate the input tensors 202 and 204. The tensor circuitry 360 includes an example of the dot product circuit 310 that has a 12-bit output datapath and, correspondingly, a normalization circuit 330 that outputs an 11 bit mantissa M. An adder 362 may sum the exponents to produce a 9-bit exponent. The count of leading zeros (c) from the normalization circuit 330 may be added to a bias value, less 10 in an adder 364. The bias value is specified for the particular floating-point format that is being used. For example, in FP32, the bias is specified to be 127 (approximately in the middle of values 0 to 255 as can be encoded by an 8-bit exponent). The bias allows the floating point format to encode positive and negative exponents. The resulting 8-bit exponent is subtracted 366 from the output of the adder 362 to obtain a shared exponent for the tensor.

As mentioned above, unlike the floating-point adder 206A, which uses a single path calculation, the floating-point adder 206B uses a multi-path arithmetic logic unit (ALU). This is a novel architecture—namely, rather than use two paths as may be done with some multipath floating-point ALUs, the floating-point adder 206B uses three paths. Of these there, one is a close path and two are “far” paths. The far paths include a top far path that may operate in a similar manner to far paths of previous floating-point adders, as well as a bottom far path where a smaller mantissa is shifted out of the mantissa precision (the RGS bits may still be set, and the rounding applied in a separate adder). Referring again to FIG. 6, the various paths of the floating-point adder 206B may include:
The close (near) path 300. This path may be used for one of two alignments (e.g., using a 2-input MUX). This path may perform 12-bit subtraction, CLZ, and normalization.
The top far path 302. This path is used in precision shifts, handling alignments of up to 11 positions (both sums and differences). The top far path 302 may not be used when the close path 300 is active. The top far path 302 may not handle any massive cancellations. Thus, the result is 1X., 1.X or 0.1X.
The bottom far path 304. This path is used in out of precision shifts. The bottom far path 304 handles alignments of up to 12 positions (addition and subtraction) and fuses 2's complement with rounding.

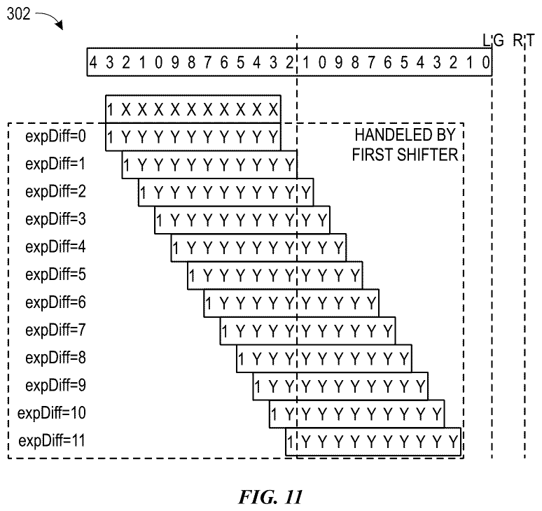

FIG. 11 illustrates an alignment of the tensors X and Y in the top far path 302. In the top far path 302, the smaller mantissa of the tensor Y (mY) may be shifted to account for an exponent difference of up to 11. For example, a right shifter may be used to align mY. The maximum shift is 11 bits, and the shifter produces an output that is 22 bits wide (11+11(shift)).

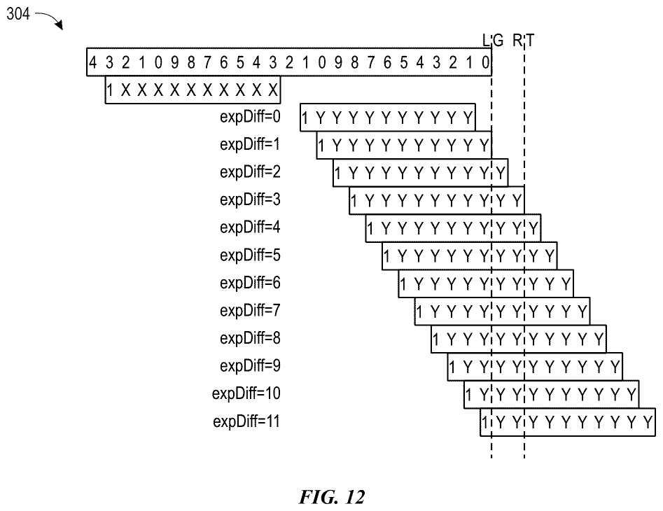

FIG. 12 illustrates an alignment of the tensors X and Y in the bottom far path 304. In the bottom far path 304, if the exponent difference is larger than or equal to 25, then the contribution of the shifted mY value (added or subtracted) is less than half of unit of least precision (ULP). In the alignment illustration of FIG. 12, L refers to last bit position, G refers to a guard bit position, R refers to a round bit position, and T refers to a “sticky” bit. In the case of addition, the “less-than-half-ulp” quantity can simply be dropped. But in the case of subtraction, it would produce a string of ‘1’s, which after rounding to nearest would round again to the original value. Consequently, this may be avoided by dropping the value in the first place.

If the operation to perform in the bottom far path 304 is addition, due to the relative alignments of the two mantissas (mX and shifted mY) in the bottom far path 304 (where expDiff>=12), the sum of the aligned mantissas cannot produce a carry-out (e.g., no growth).

In this case, the alignment is known (e.g., leading one does not change). Therefore:

$$T = T or R$$

$$R = G$$

A rounding bit, added into the last (L) bit, may be computed as follows:

$$Rnd = R ( T + L )$$

In the case of subtraction, if the initial sticky bit (T) is 1, then at least one bit shifted past the R position is a “1”. The 1's complement makes this a zero, which allows absorbing the “+1” that is done in order to complete 2's complement. Here, the sticky bit (T) remains 1, so no “+1” may be added to complete 2's complement. If the initial sticky bit (T) is 0, then all of the shifted-out bits are zero. 1's complement makes all bits 1, and the “+1” makes those bits “0” again. Therefore, the sticky bit (T) remains at “0” but “+1” is used in the “R” position.

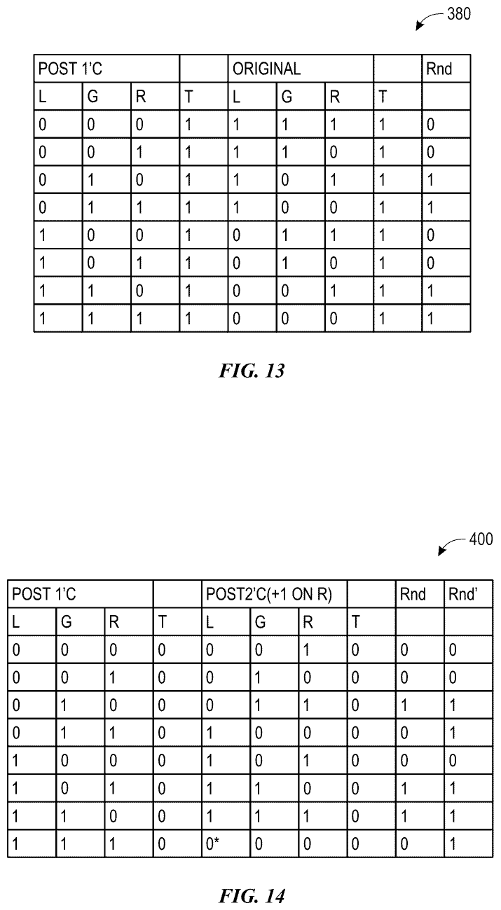

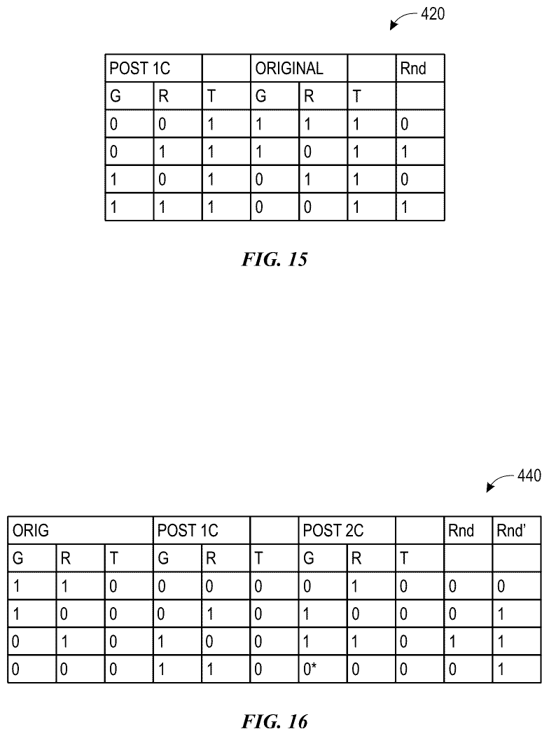

FIGS. 13-16 are truth tables relating to the scenarios described above for rounding in the bottom far path 304. In particular, FIG. 13 is a truth table 380 that represents rounding values (Rnd) that may be selected in the bottom far path 304 after performing 1's complement (Post 1′c) and the sticky bit (T) is equal to 1. In the truth table 380, the rounding value Rnd=not(G). FIG. 14 is a truth table 400 that represents rounding values (Rnd and Rnd′) that may be selected in the bottom far path 304 after performing 1's complement (Post 1′c) followed by 2's complement (Post 2′c) when the sticky bit (T) is equal to 0. In the truth table 400, Rnd′=Lnot(G)R+not(L)(not(G and R)). Note that, in the case where mX=1, subtraction moves the MSB right by one position. The round bit (Rnd) then may be added to the guard bit (G) position. In this context, FIG. 15 is a truth table 420 that represents rounding values (Rnd) that may be selected in the bottom far path 304 after performing 1's complement (Post 1C), where rnd=not(R) for the case when mX=1 and when the sticky bit (T) is equal to 1. FIG. 16 is a truth table 440 that represents rounding values (Rnd and Rnd′) that may be selected in the bottom far path 304 after performing 1's complement (Post IC) and 2's complement (Post 2C), where Rnd′=not(G)+not(R) for the case when mX=1 and when the sticky bit (T) is equal to 0.

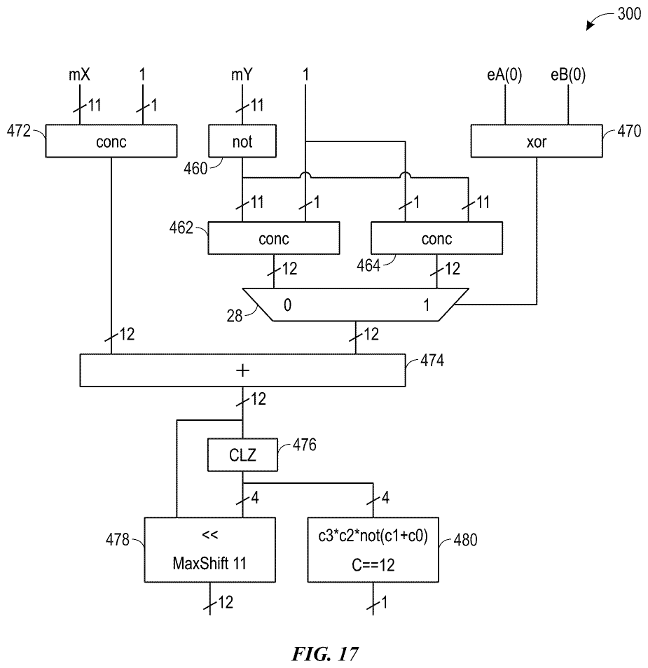

With the above in mind, FIG. 17 is a block diagram of the close (near) path 300. The close path 300 may receive the mantissas of the tensors mX and mY and the LSBs of their exponents eA(0) and eB(0). The value mY may have 11 bits and may enter a NOT gate 460. A concatenate circuit 462 may concatenate an LSB of 1 to mY and a concatenate circuit 464 may concatenate an MSB of 1 to mY and provide the outputs to a multiplexer 468. The output of the multiplexer 468 may be chosen based on an XOR gate 470 of the LSB of exponents eA(0) and eB(0). Meanwhile, a concatenate circuit 472 may concatenate an LSB of 1 to mX. This value may be added in adder circuitry 474 to the output of the multiplexer 468. A count leading zeros (CLZ) circuit 476 and shifting circuitry 478 may renormalize the combination with a maximum shift of 11. Carry circuitry 480 may calculate a carry bit based on the count of leading zeros from the CLZ circuit 476. In this way, the close path may be calculated for 11-bit signals. Only one result will be used, determined by the result of the XOR gate 470 between the LSBs of expX and expY to decide one of two alignments. That is, if the bit is 0 the exponents are understood to be equal, whereas if the bit is 1, it is understood that there is a 1-bit left shift.

Subtraction is performed (the result will be discarded if the operation was an addition in any case, and the result of the top far path 302—which is computed at the same time—is used). In the near path 300, the CLZ circuit 476 is used to normalize. A maximum of 11 zeros may be checked; the circuit may look at 12 bits. If the leading zero count=12 then there is a condition of (A-A) and thus a value of 0 may be returned. The near path 300 may be completed by normalizing (e.g., left shift, 11 positions max, 12 bits in).

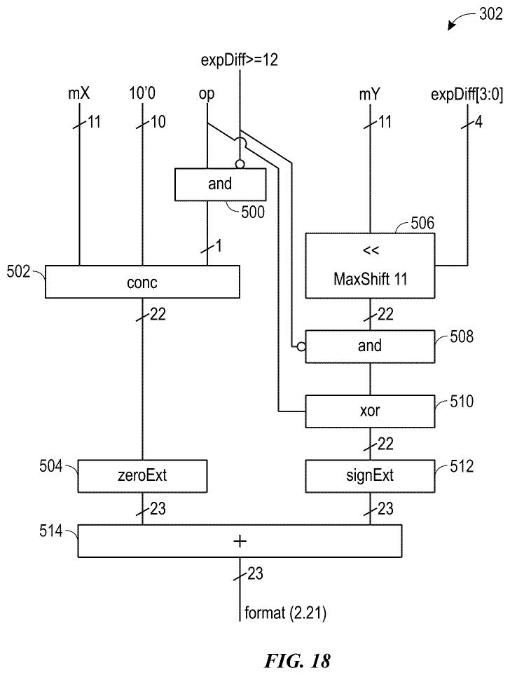

FIG. 18 is a block diagram of the top far path 302. An AND gate 500 may receive an “op” code indicating whether subtraction is to be applied as well as a Boolean indication that the exponent difference is not greater than 12. A concatenate circuit 502 may concatenate, to the LSB of the value mX, a 10′0 value (ten zeros) and the output of the AND gate 500. Zero extension circuitry 504 may add zeros into the MSB up to a total width of 23 bits (e.g., the zero extension circuitry 504 may add one zero to the MSB of the 22-bit signal from the concatenate circuit 502). On the righthand side of the circuitry of the top far path 302, a shifter 506 may shift mY up to 11 bits. The result enters an AND gate 508 that also receives the Boolean indication that the exponent difference is not greater than 12. The output of the AND gate 508 enters an XOR gate 510 along with the “op” code that indicates whether subtraction is to be applied. Sign extension circuitry (signExt) 512 may apply sign extensions as appropriate and the result may be added in an adder 514 to the output of the zero extension circuitry 504. Note that this is similar to far path circuits of regular floating-point adders, but in this case the circuitry is sized to the expected tensor dot product precision (e.g., 11-bits). The right shifter 506 of up to 11 positions is used to align data. Shift out (when expDiff>=12) is handled by the “and” gate 508 (pulled to zero otherwise). The output takes one of 3 forms: 1X.X, 01.X or 00.1X (normalization using MSB)

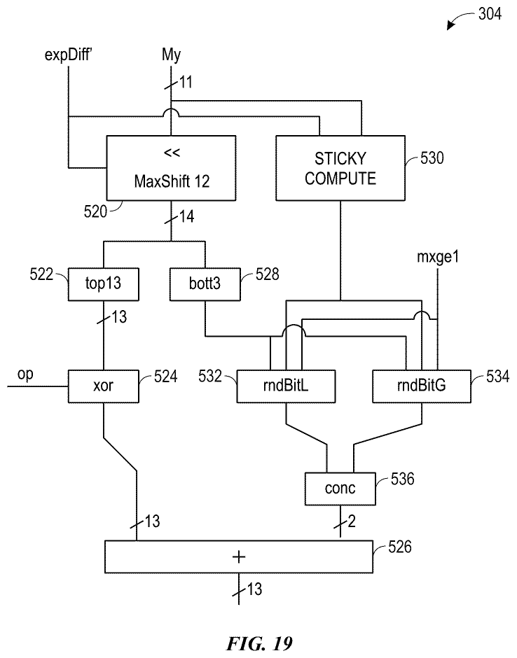

FIG. 19 illustrates a block diagram of the bottom far path 304. The mantissa mY may enter a shifter 520 that may shift a maximum of 12 bits to the right. The top 13 bits 522 may enter an XOR gate 524 with the “op” code to indicate whether subtraction is to be applied. The resulting 13 bits output by the XOR gate 524 may enter addition circuitry 526. The bottom 3 bits 528 output by the shifter 520 and a result of a sticky compute 530 may enter “L” bit position rounding logic 532 and “G” bit position rounding logic 534. These outputs may be concatenated 536 and added to the output of the XOR gate 524 in the adder 526.

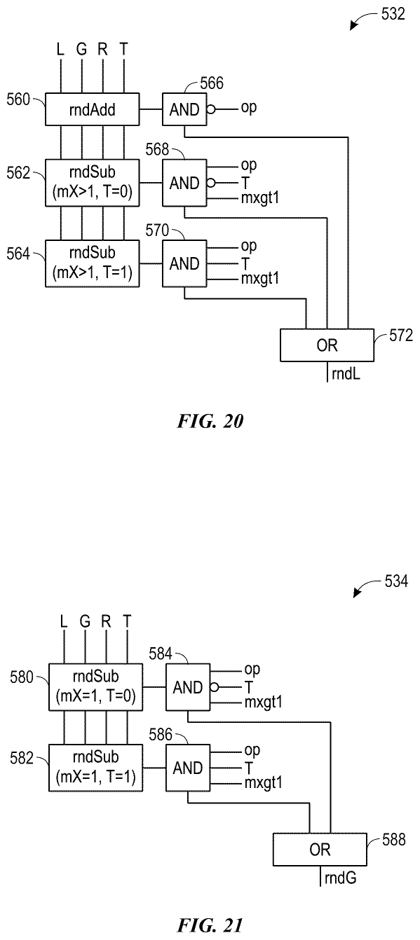

FIG. 20 represents a block diagram of the “L” bit position rounding logic 532. The L, G, R, T bit position values may enter a round addition block 560, a round subtraction block 562 where mX is greater than 1 and the sticky bit T is equal to 0, and a round subtraction block 564 where mX is greater than 1 and the sticky bit T is equal to 1. An AND gate 566 may receive the output of the round addition block 562 and the “op” code indicating whether to perform subtraction. An AND gate 568 may receive the output of the round subtraction block 562, the “op” code indicating whether to perform subtraction, an inverse of the sticky bit (T) value, and a Boolean value indicating that mX is greater than 1. An AND gate 570 may receive the output of the round subtraction block 564, the “op” code indicating whether to perform subtraction, the sticky bit (T) value, and a Boolean value indicating that mX is greater than 1. The outputs of the AND gates 566, 568, and 570 may enter an OR gate 572, which may output an indication of whether to round for the “L” bit position, rndL.

FIG. 21 represents a block diagram of the “G” bit position rounding logic 534. The L, G, R, T bit position values may enter a round subtraction block 580 where mX is equal to 1 and the sticky bit T is equal to 0 and a round subtraction block 582 where mX is greater than 1 and the sticky bit T is equal to 1. An AND gate 584 may receive the output of the round subtraction block 580, the “op” code indicating whether to perform subtraction, an inverse of the sticky bit (T) value, and an inverse of the Boolean value indicating that mX is greater than 1. An AND gate 586 may receive the output of the round subtraction block 582, the “op” code indicating whether to perform subtraction, the sticky bit (T) value, and an inverse of the Boolean value indicating that mX is greater than 1. The outputs of the AND gates 584 and 586 may enter an OR gate 588, which may output an indication of whether to round for the guard (G) bit position.

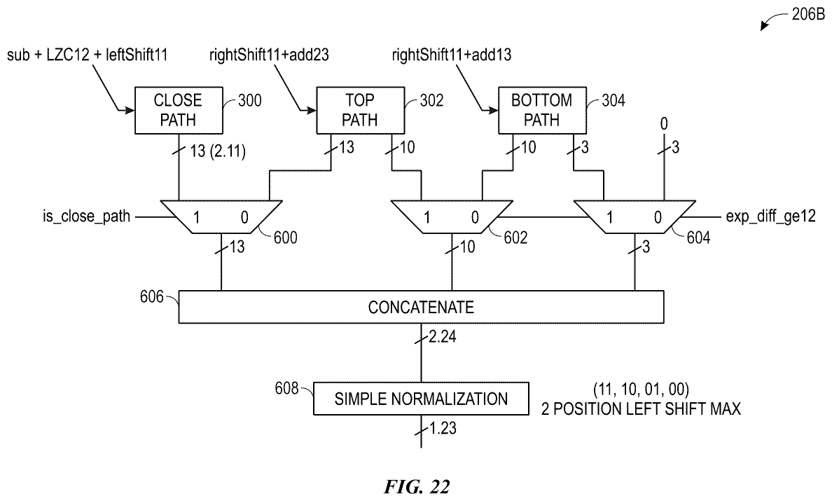

As seen in FIG. 22, the outputs of the close path 300, top far path 302, and the bottom far path 304 may be selected by multiplexers 600, 602, and 604 and concatenated 606. Simple normalization 608 may also be performed. The selection signal for the multiplexer 600 may indicate whether the close path 300 was used based on the characteristics of the tensors and the operation to be performed. The selection signal of the multiplexers 602 and 604 may be based on whether the exponent difference was greater than 12 (e.g., which indicates whether the least significant bits of the operation fell beyond the precision of the output format). In effect, the three circuits are combined. Different output bits from the three circuits are mapped to different portions of the 25-bit result—this may not involve rounding at this point, but rather only a possible 2-bit range normalization.

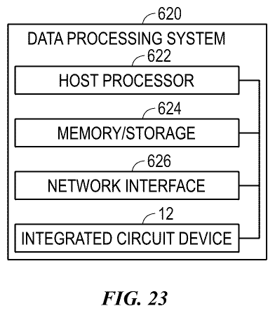

The circuit discussed above may be implemented on the integrated circuit system 12, which may be a component included in a data processing system, such as a data processing system 620, shown in FIG. 23. The data processing system 620 may include the integrated circuit system 12 (e.g., a programmable logic device), a host processor 622, memory and/or storage circuitry 624, and a network interface 626. The data processing system 620 may include more or fewer components (e.g., electronic display, user interface structures, application specific integrated circuits (ASICs)). Moreover, any of the circuit components depicted in FIG. 10 may include the integrated circuit system 12. The host processor 622 may include any of the foregoing processors that may manage a data processing request for the data processing system 620 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 624 may include random access memory (RAM), read-only memory (ROM), one or more hard drives, flash memory, or the like. The memory and/or storage circuitry 624 may hold data to be processed by the data processing system 620. In some cases, the memory and/or storage circuitry 624 may also store configuration programs (e.g., bitstreams, mapping function) for programming the integrated circuit system 12. The network interface 626 may allow the data processing system 620 to communicate with other electronic devices. The data processing system 620 may include several different packages or may be contained within a single package on a single package substrate. For example, components of the data processing system 620 may be located on several different packages at one location (e.g., a data center) or multiple locations. For instance, components of the data processing system 620 may be located in separate geographic locations or areas, such as cities, states, or countries.

The data processing system 620 may be part of a data center that processes a variety of different requests. For instance, the data processing system 620 may receive a data processing request via the network interface 626 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the floating-point adder of this disclosure may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. Circuitry comprising:
first input circuitry to receive a first tensor in a fixed-point format having a first shared exponent;
second input circuitry to receive a second tensor in the fixed-point format with a second shared exponent; and
addition circuitry to add the first tensor and the second tensor, without first converting the first tensor and the second tensor to a floating-point format, to obtain a result in the floating-point format.

EXAMPLE EMBODIMENT 2. The circuitry of example embodiment 1, wherein the addition circuitry is to convert the first tensor and the second tensor to the floating-point format at a denormalization stage.

EXAMPLE EMBODIMENT 3. The circuitry of example embodiment 2, wherein the denormalization stage of the addition circuitry comprises a bidirectional bit-shifter.

EXAMPLE EMBODIMENT 4. The circuitry of example embodiment 3, wherein the bidirectional bit-shifter comprises a unidirectional bit shifter and selectable reverse circuitry.

EXAMPLE EMBODIMENT 5. The circuitry of example embodiment 1, wherein the addition circuitry comprises three paths based on a difference between the first shared exponent and the second shared exponent.

EXAMPLE EMBODIMENT 6. The circuitry of example embodiment 5, wherein the three paths of the addition circuitry comprise a close path corresponding to the difference between the first shared exponent and the second shared exponent being 0 or 1.

EXAMPLE EMBODIMENT 7. The circuitry of example embodiment 5, wherein the three paths of the addition circuitry comprise a top far path corresponding to the difference between the first shared exponent and the second shared exponent being less than or equal to a bit depth of the first tensor or the second tensor.

EXAMPLE EMBODIMENT 8. The circuitry of example embodiment 5, wherein the three paths of the addition circuitry comprise a bottom far path corresponding to the difference between the first shared exponent and the second shared exponent being greater than a bit depth of the first tensor or the second tensor.

EXAMPLE EMBODIMENT 9. The circuitry of example embodiment 8, wherein the bottom far path comprises circuitry that fuses a 2's complement operation and a rounding operation.

EXAMPLE EMBODIMENT 10. The circuitry of example embodiment 5, wherein the addition circuitry is configurable to selectively concatenate results from the three paths.

EXAMPLE EMBODIMENT 11. A programmable logic device comprising:
programmable logic circuitry; and
digital signal processing blocks embedded among the programmable logic circuitry, wherein the digital signal processing blocks are configurable to implement a floating-point adder to add two input tensors having respective shared exponents and output a floating-point result.

EXAMPLE EMBODIMENT 12. The programmable logic device of example embodiment 11, wherein the floating-point adder comprises a single path.

EXAMPLE EMBODIMENT 13. The programmable logic device of example embodiment 11, wherein the floating-point adder comprises multiple paths selected based on a difference between the respective shared exponents.

EXAMPLE EMBODIMENT 14. The programmable logic device of example embodiment 13, wherein the floating-point adder comprises a close path selected based on a difference between the respective shared exponents being 0 or 1.

EXAMPLE EMBODIMENT 15. The programmable logic device of example embodiment 13, wherein the floating-point adder comprises a bottom far path selected based on a difference between the respective shared exponents exceeding a mantissa size of the output floating-point result.

EXAMPLE EMBODIMENT 16. The programmable logic device of example embodiment 15, wherein the bottom far path is the only path of the multiple paths that computes rounding based on bits exceeding the mantissa size of the output floating-point result.

EXAMPLE EMBODIMENT 17. The programmable logic device of example embodiment 13, wherein the floating-point adder comprises a top far path selected based on a difference between the respective shared exponents not exceeding a mantissa size of the output floating-point result.

EXAMPLE EMBODIMENT 18. Circuitry comprising:
input circuitry to receive a first fixed-point tensor and a second fixed-point tensor;
denormalization circuitry configurable to apply relative normalizations between the first fixed-point tensor and the second fixed-point tensor to convert the first fixed-point tensor and the second fixed-point tensor to floating point; and
addition circuitry to add the first floating point tensor and the second floating point tensor.

EXAMPLE EMBODIMENT 19. The circuitry of example embodiment 18, wherein the denormalization circuitry of the addition circuitry comprises a bidirectional bit-shifter.

EXAMPLE EMBODIMENT 20. The circuitry of example embodiment 19, wherein the bidirectional bit-shifter comprises a unidirectional bit shifter and selectable reverse circuitry.

What is claimed is:

1. Circuitry comprising:
first input circuitry to receive a first tensor in a fixed-point format having a first shared exponent;
second input circuitry to receive a second tensor in the fixed-point format with a second shared exponent; and
addition circuitry to add the first tensor and the second tensor, without first converting the first tensor and the second tensor to a floating-point format, to obtain a result in the floating-point format.

2. The circuitry of claim 1, wherein the addition circuitry is to convert the first tensor and the second tensor to the floating-point format at a denormalization stage.

3. The circuitry of claim 2, wherein the denormalization stage of the addition circuitry comprises a bidirectional bit-shifter.

4. The circuitry of claim 3, wherein the bidirectional bit-shifter comprises a unidirectional bit shifter and selectable reverse circuitry.

5. The circuitry of claim 1, wherein the addition circuitry comprises three paths based on a difference between the first shared exponent and the second shared exponent.

6. The circuitry of claim 5, wherein the three paths of the addition circuitry comprise a close path corresponding to the difference between the first shared exponent and the second shared exponent being 0 or 1.

7. The circuitry of claim 5, wherein the three paths of the addition circuitry comprise a top far path corresponding to the difference between the first shared exponent and the second shared exponent being less than or equal to a bit depth of the first tensor or the second tensor.

8. The circuitry of claim 5, wherein the three paths of the addition circuitry comprise a bottom far path corresponding to the difference between the first shared exponent and the second shared exponent being greater than a bit depth of the first tensor or the second tensor.

9. The circuitry of claim 8, wherein the bottom far path comprises circuitry that fuses a 2's complement operation and a rounding operation.

10. The circuitry of claim 5, wherein the addition circuitry is configurable to selectively concatenate results from the three paths.

11. A programmable logic device comprising:
programmable logic circuitry; and
digital signal processing blocks embedded among the programmable logic circuitry, wherein the digital signal processing blocks are configurable to implement a floating-point adder to add two input tensors having respective shared exponents and output a floating-point result.

12. The programmable logic device of claim 11, wherein the floating-point adder comprises a single path.

13. The programmable logic device of claim 11, wherein the floating-point adder comprises multiple paths selected based on a difference between the respective shared exponents.

14. The programmable logic device of claim 13, wherein the floating-point adder comprises a close path selected based on the difference between the respective shared exponents being 0 or 1.

15. The programmable logic device of claim 13, wherein the floating-point adder comprises a bottom far path selected based on a difference between the respective shared exponents exceeding a mantissa size of the output floating-point result.

16. The programmable logic device of claim 15, wherein the bottom far path is the only path of the multiple paths that computes rounding based on bits exceeding the mantissa size of the output floating-point result.

17. The programmable logic device of claim 13, wherein the floating-point adder comprises a top far path selected based on a difference between the respective shared exponents not exceeding a mantissa size of the output floating-point result.

18. Circuitry comprising:
input circuitry to receive a first fixed-point tensor and a second fixed-point tensor;
denormalization circuitry configurable to apply relative normalizations between the first fixed-point tensor and the second fixed-point tensor to convert the first fixed-point tensor and the second fixed-point tensor to floating point; and
addition circuitry to add the first floating point tensor and the second floating point tensor.

19. The circuitry of claim 18, wherein the denormalization circuitry of the addition circuitry comprises a bidirectional bit-shifter.

20. The circuitry of claim 19, wherein the bidirectional bit-shifter comprises a unidirectional bit shifter and selectable reverse circuitry.
